(19) United States
(12) Patent Application Publication
(10) Pub. No.: US 2026/0109172 A1
(43) Pub. Date: Apr. 23, 2026

(54) PAINTBRUSH CLEANING DEVICE WITH TWO ROTATABLE BRUSHES

(71) Applicant: Lavabrush AB, Veberöd (SE)

(72) Inventors: Patrik Sjöland, Veberöd (SE); John Tuneld, Upplands Väsby (SE)

(73) Assignee: Lavabrush AB, Veberöd (SE)

(21) Appl. No.: 19/167,873

(22) PCT Filed: Mar. 26, 2024
(86) PCT No.: PCT/SE2024/050270

§ 371 Date: Sep. 23, 2025

(30) Foreign Application Priority Data
Mar. 29, 2023 (SE) 2350359-2

(51) Int. Cl. B44D 3/00; A46B 3/16; A46B 13/00; A46B 13/04; A46B 17/06

(52) U.S. Cl. CPC B44D 3/006; A46B 3/16; A46B 13/001; A46B 13/04; A46B 17/06; A46B 2200/202

(57) ABSTRACT

Provided is a paintbrush cleaning device having: a container arranged to hold a cleaning liquid; a first twisted-in-wire brush rotatably arranged in the container; a second twisted-in-wire brush rotatably arranged in the container; and a drivetrain arranged to rotate the brushes in contra-rotational sync. Each of the first and second brushes comprises: twisted stem wires defining a central longitudinal axis of rotation of the brush, and a plurality of bristles of equal length held by the twisted stem wires. The first and second brushes are arranged such that the axes of rotation are fixed in relation to the container and parallel to each other such that a paintbrush can be moved through an opening at a top of the container and in between the axes of rotation to be cleaned by the brushes when rotating.

### TECHNICAL FIELD

The present disclosure relates to a paintbrush cleaning device.

### BACKGROUND

There is a need for efficient cleaning of used paintbrushes, e.g. at building sites, without having to use toxic solvents and without releasing microplastics from the paint into the environment.

### SUMMARY

It is an objective of the present invention to provide an improved paintbrush cleaning device with efficient mechanical cleaning, obviating the need for organic solvents.

According to an aspect of the present invention, there is provided a paintbrush cleaning device, comprising: a container arranged to hold a cleaning liquid; a first twisted-in-wire brush, rotatably arranged in the container; a second twisted-in-wire brush, rotatably arranged in the container; and a drivetrain arranged to rotate the brushes in contra-rotational sync. Each of the first and second brushes comprises: twisted stem wires defining a central longitudinal axis of rotation of the brush, and a plurality of bristles of equal length held by the twisted stem wires, the bristle ends defining a diameter of the brush. The first and second brushes are arranged such that the axes of rotation are fixed in relation to the container and parallel to each other such that a paintbrush can be moved through an opening at a top of the container and in between the axes of rotation to be cleaned by the brushes when rotating.

According to another aspect of the present invention, there is provided a use of an embodiment of the paintbrush cleaning device of the present disclosure. The use comprises: rotating the brushes in contra-rotational sync such that the bristles of both brushes move down from the top of the container between the axes of rotation; and moving a paintbrush through the opening at the top of the container and in between the axes of rotation such that the paintbrush is cleaned by the rotating brushes.

By the bristles of the twisted-in-wire brushes moving through the bristles of the paintbrush during rotation of the twisted-in-wire brushes, paint is removed from the paintbrush. The cleaning liquid, preferably water, wets both the twisted-in-wire brushes and the paintbrush, aiding in the removal of the paint which may be dissolved in the cleaning liquid or, preferably, sediment to the bottom of the container. With the paint particles, typically containing environmentally harmful microplastics, sedimenting to the bottom, the cleaning liquid remains clean for longer, enabling cleaning a higher number of paint brushes before needing to exchange the cleaning liquid, reducing the consumption of cleaning liquid e.g. drinking water. When in use, the twisted-in-wire brushes rotate against each other such that the bristles move downward between the axes of the twisted-in-wire brushes, facilitating brushing through the paintbrush introduced through the top opening of the container and in between the twisted-in-wire brushes arranged below the opening. The paintbrushes may thus be cleaned fast and with reduced wear.

By using twisted-in-wire brushes, the bristles form spirals around the longitudinal axis of each brush, whereby bristle ends of said bristle spirals work through a paintbrush being cleaned by the rotating brushes, spiralling in a longitudinal direction of the twisted-in-wire brushes, improving the mechanical processing of the paintbrush. Also, the spiral form of the twisted-in-wire brushes allow the two twisted-in-wire brushes to overlap without the bristles of the twisted-in-wire brushes colliding with each other during rotation of the twisted-in-wire brushes. Since the rotation is in contra-rotational sync, the spirals may be fixed in relation to each other such that the bristle ends of overlapping twisted-in-wire brushes do not collide neither when not rotating nor when rotating, by the spiralling of the first brush mirroring the spiralling of the second brush, but with a longitudinal shift, during rotation.

It is to be noted that any feature of any of the aspects may be applied to any other aspect, wherever appropriate. Likewise, any advantage of any of the aspects may apply to any of the other aspects. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic side view of a paintbrush cleaning device in longitudinal section, in accordance with some embodiments of the present invention.

FIG. 2 is a schematic side view of a paintbrush cleaning device in cross section, in accordance with some embodiments of the present invention.

FIG. 3 is a schematic cross-sectional view of overlapping first and second twisted-in-wire brushes, in accordance with some embodiments of the present invention.

FIG. 4 is a schematic cross-sectional view of a paintbrush cleaning device, illustrating flow of cleaning liquid therein, in accordance with some embodiments of the present invention.

FIG. 5 is a schematic flow chart of a method of using a paintbrush cleaning device, in accordance with some embodiments of the present invention.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

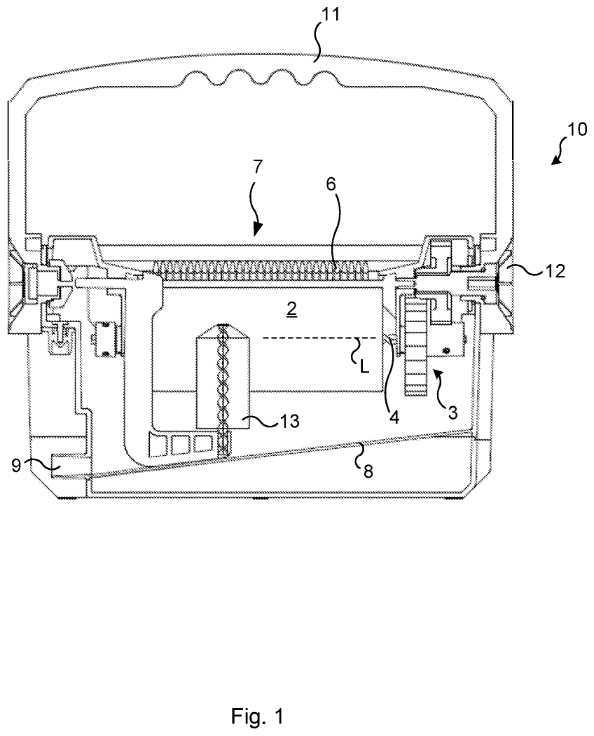

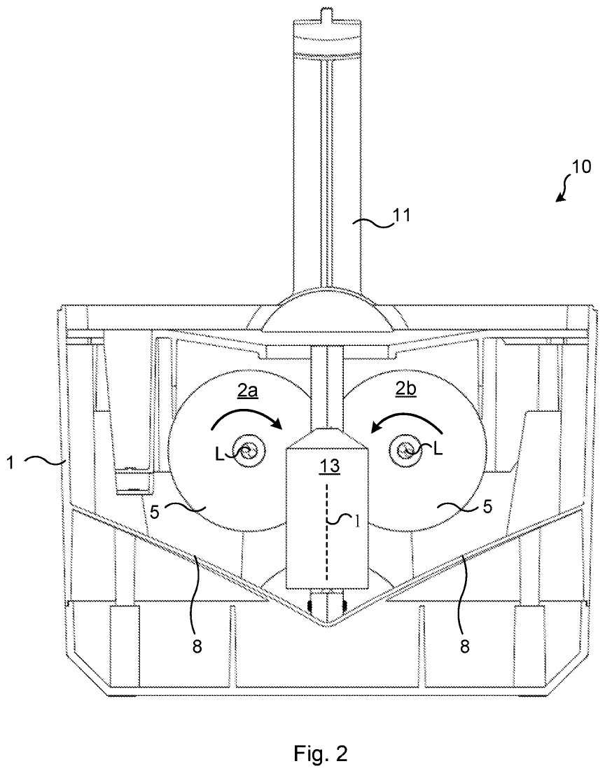

FIGS. 1 and 2 show an example of a paintbrush cleaning device 10 comprising a container 1, here with an optional handle 11 for facilitating carrying of the container 1. The container 1 may have any suitable size but may for instance have a length (in the longitudinal direction) within the range of 200-400 mm, e.g. 270 mm, a width (in the transverse direction) within the range of 140-300 mm, e.g. 200 mm, and/or a height (without lid) within the range of 120-300 mm, e.g. 145 mm (180 mm including an optional lid). The container 1 is arranged to be positioned on top of a surface such that the top 7 of the container faces upwards and to hold a cleaning liquid. The cleaning liquid is preferably water or water based, e.g. water only or water with a detergent. The level of the cleaning liquid is such that the rotatably arranged brushes 2 are wetted by the cleaning liquid during rotation, but without the cleaning liquid leaking out from the container 1 via the opening 6 in the top 7.

A pair of twisted-in-wire brushes 2, herein called a first twisted-in-wire brush 2a and a second twisted-in-wire brush 2b, are rotatably arranged in the container 1. Twisted-in-wire brushes are also called tube brushes or flue brushes. A twisted-in-wire brush 2 is made from filaments positioned between stem wires 4 which are twisted to hold the filaments, forming the bristles 5 of the brush, two bristles per filament, one on each side of the longitudinal axis L along which the twisted stem wires 4 extend. By the stem wires 4 being twisted, and the filaments being held between the twisted wires, the bristles form a spiral around the axis L. The bristles all have approximately the same length, whereby the ends of the bristles define a diameter, and a circumference, of the brush 2. The length of the brush is herein regarded as the distance along the longitudinal axis L having bristles 5.

Each of the first and second brushes 2a and 2b is arranged in the container 1 such that the longitudinal axis L is fixed and functions as an axis of rotation of the brush. Typically, the first and second brushes 2a and 2b have the same diameter and the same length. The brushes 2a and 2b are arranged in the container 1 such that the longitudinal axes L are parallel to each other and in a horizontal plane when the container is placed with the top 7 facing upward, e.g. in, or in parallel with, a plane of the surface of the cleaning liquid when the paintbrush cleaning device 10 is in use. The brushes 2a and 2b are arranged in relation to the opening 6 in the top 7 of the container 1 such that a paintbrush can be moved into the container 1 via the opening 7 and in between the brushes 2a and 2b, i.e. between the two axes L thereof, to be cleaned by the brushes 2a and 2b.

The first and second brushes 2a and 2b are connected to a drivetrain 3, e.g. comprising gears in mesh with each other, typically within the container 1, for rotating the two brushes in contra-rotational sync, as indicated by the curved arrows in FIG. 2. A connection 12 to the drivetrain 3 allows a drive, typically outside of the container 1, to be connected to and drive the drivetrain, rotating the brushes 2a and 2b via the drivetrain. The drive can e.g. be or comprise a crank and/or a motor such as an electrical motor, e.g. of an electrical drill or screwdriver which is connected via the connection 12. The drive train 3 may e.g. comprise three gears, an upper gear formed with, or otherwise fastened to, the connection 12 and arranged to be turned by the drive, and a respective lower gear of each of the first and second brushes 2a and 2b, fastened to the end of the brush and sharing axis of rotation with said brush 2, and in mesh with the upper gear, below said upper gear, allowing them to be turned in contra-rotational sync by the upper gear. Thus, the axis of rotation of the upper gear is above the respective axes of rotation of the lower gears. By this arrangement, the stem wires 4 and the longitudinal axes L of the first and second brushes 2a and 2b can be located below the horizontal non-agitated surface of the cleaning liquid (when the brushes 2 are not rotating), with less risk of leakage at the connection 12 to the drive since the rotational axis of the upper gear may still be above the liquid surface. This allows for cleaning of the paintbrush further below the liquid surface, making the cleaning more efficient.

In some embodiments of the present invention, the drivetrain 3 comprises an upper gear arranged to be turned by a drive, and a respective lower gear of each of the first and second brushes 2a and 2b fastened to an end of said brush 2a or 2b and in mesh with the upper gear. In some embodiments, the upper gear is fastened to the connection 12 through a side wall of the container 1, allowing a drive outside of the container 1 to turn the upper gear via the connection 12.

The inside bottom 8 of the container 1 preferably slants, i.e. is inclined, towards an opening 9 for tapping the cleaning liquid from the container, to facilitate the removing of the cleaning liquid e.g. while the container, typically an outside bottom surface thereof, remains on top of, and in contact with, a horizontal surface e.g. of a table or floor. Thus, while the container 1 stands on the horizontal surface, the cleaning liquid can easily be removed via the outlet opening 9 by virtue of the inclined inside surface of the bottom 8. In some embodiments, as shown in FIGS. 1 and 2, the bottom 8 may be inclined towards the outlet opening 9 in the longitudinal direction and/or in the transverse (cross) direction of the container 1. The outlet opening 9 is sealable with a liquid-tight, e.g. water-tight, seal which is openable or removable for removing the cleaning liquid when desirable. Particles, e.g. flakes, of the paint removed from one or more paintbrushes sedimented to the bottom 8 or suspended or floating in the cleaning liquid are removed with the cleaning liquid via the outlet opening and can easily be deposited at a recycling station or the like. Also, by the bottom 8 being inclined towards the outlet opening 9 in the longitudinal direction and/or in the transverse (cross) direction of the container 1, particles, e.g. flakes, of the paint removed from one or more previously cleaned paintbrushes may sediment to the bottom 8 at the opening 9, without being swirled into the flow of cleaning liquid cleaning the paintbrush currently being cleaned, improving the cleaning of further paintbrushes and increasing the number of paintbrushes that can be cleaned before needing to exchange the cleaning liquid.

In some embodiments, the paintbrush cleaning device 10 comprises a right-circular cylindrical device 13 arranged in a fixed position in the container 1. The cylindrical device 13 has a longitudinal axis l which is perpendicular to the plane in which the axes of rotation L lie. The cylindrical device 13 extends along its longitudinal axis 1 from a base of the cylindrical device, which base is fixed to the container 1, below the first and second brushes 2a and 2b, up between said first and second brushes, e.g. up to below, at or above the plane of the axes L or rotation of the first and second brushes 2a and 2b. Preferably, the cylindrical device 13 extends towards (below, to or past) an imagined line halfway between, and in parallel with, the axes L of rotation. The cylindrical device 13 may improve the cleaning of a paintbrush by spreading the bristles thereof as the paintbrush is moved downward against the cylindrical device 13. The cylindrical device 13 may have a conically shaped top, to facilitate the spreading of the bristles of the paintbrush as the paintbrush is moved down against said conically shaped top. The use of the cylindrical device 13 may be especially advantageous for cleaning thick paintbrushes, e.g. round paintbrushes. The cylindrical device 13 may be positioned at a side of the container 1, allowing a paintbrush to be moved down though the top opening 6 of the container 1, in between the rotating first and second brushes 2a and 2b, either on to the cylindrical device 13 for spreading the bristles of the paintbrush, or to the side of the cylindrical device 13 when interaction between the paintbrush and the cylindrical device is not desired.

In some embodiments, the cylindrical device 13 has a diameter within the range of 20-35 mm, preferably 25-30 mm. Additionally or alternatively, in some embodiments, the cylindrical device 13 has a length within the range of 40-70 mm, preferably 50-60 mm. Conveniently, also the cylindrical device 13 is a twisted-in-wire brush, which has been shown to suitably spread the bristles of a paintbrush to improve the cleaning of said paintbrush by the rotating first and second brushes 2a and 2b. The bristles of the twisted-in-wire brush of the cylindrical device 13 may have a diameter within the range of 0.2-0.3 mm.

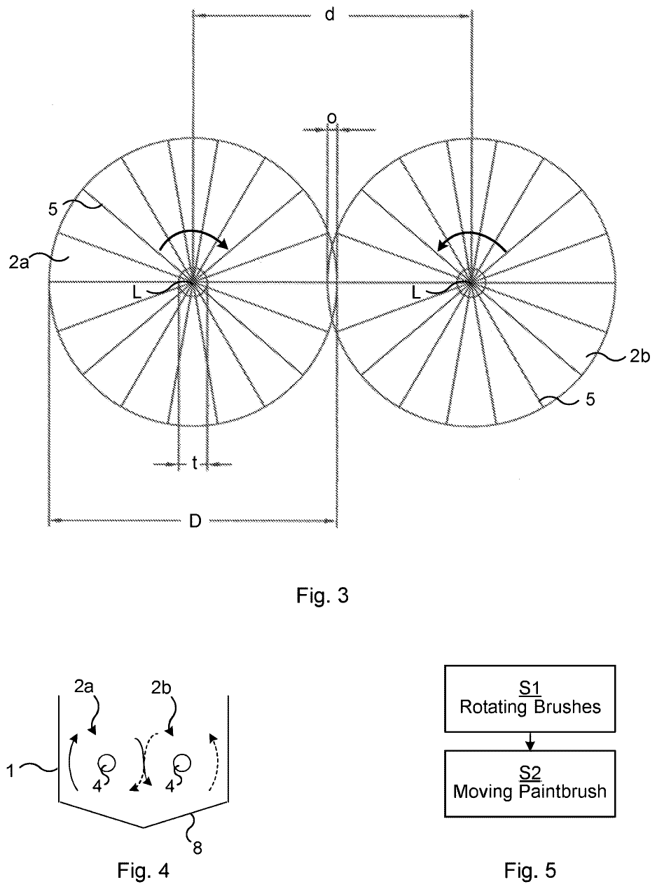

FIG. 3 is a cross-sectional view of the first and second brushes 2a and 2b. Each of the brushes 2 has a diameter D, defined by the ends of the bristles 5 of the brush, whereby the diameter D corresponds to twice the bristle length. The twisted stem wires 4, holding the bristles 5 in place by pinching the filaments forming the bristles between the twisted wires, forms a longitudinal core of the brush 2 having a thickness t which may be within the range of 3-9 mm, e.g. within the range of 5-7 mm, e.g. 6 mm. A distance d between the first and second brushes 2a and 2b is defined as the distance between the respective longitudinal (and rotational) axes L of the first and second brushes 2a and 2b and may be within the range of 50-65 mm, e.g. within the range of 55-60 mm, such as 58 mm. Typically, each of the first and second brushes 2 has the same diameter D as the other one of the brushes 2. Similarly, each of the first and second brushes 2 has the same length as the other one of the brushes 2, the length being defined as the longitudinal part of the brush 2 which is provided with bristles 5.

It may be desirable with an overlap o between the first and second brushes 2a and 2b. Thus, the distance d between the brushes 2 may be less than the combined diameters D of said brushes. Such an overlap o may be at least 1 mm, e.g. within the range of 1-5 mm, such as 2 mm. In a specific example, each of the first and second brushes 2a and 2b has a diameter D of 60 mm and are positioned at a distance d from each other of 58 mm, resulting in an overlap o of 2 mm. The overlap o may improve the cleaning of a paintbrush positioned between the brushes 2 when rotating. As discussed above, the use of twisted-in-wire brushes 2 allows for an overlap o without the bristles 5 colliding with each other as the brushes rotate towards each other in contra-rotational sync.

The contra-rotational rotation of the first and second brushes 2a and 2b is illustrated by the curved arrows, indicating that the first brush 2a (left in the figure) has a clockwise rotation about its rotational axis L while the second brush 2b (right in the figure) has a counter-clockwise rotation about its rotational axis L. Thus, the respective circumference of each of the first and second brushes 2a and 2b, defined by the ends of the bristles 5 thereof, move downward between the brushes, i.e. where a paintbrush being cleaned would be positioned with the handle of the paintbrush extending upward.

It has been realised that the cleaning efficiency may be improved by careful selection of the design of the first and second brushes 2a and 2b and the bristles thereof. The length of the bristles, corresponding to half the length of the filaments used for making the twisted-in-wire brush 2, may be within the range of 25-35 mm, e.g. within the range of 28-32 mm, such as 30 mm. Additionally or alternatively, each of the bristles 5 may have a diameter within the range of 0.5-0.7 mm, e.g. within the range of 0.55-0.65 mm, such as 0.6 mm. Additionally or alternatively, the bristles 5, and the filaments from which they are formed, may be made of polyester, e.g. polybutylene terephthalate (PBT), which has been shown to have suitable properties e.g. with low water absorption (0.35%) and high durability when used in the paintbrush cleaning device 10. Additionally or alternatively, each of the brushes 2 may have a number of bristles 5 per 100 mm along the rotational axis L within the range of 300-400, e.g. within the range of 340-380 or 350 370 bristles per 100 mm. Since each filament used when producing the brush results in two bristles, the number of filaments used is half the number of bristles of the finished brush. This number of bristles per length unit of the brush 2 has been shown to improve the cleaning efficiency of the brushes. Additionally or alternatively, each of the brushes 2 has a length within the range of 100-200 mm, e.g. within the range of 120-170 mm, such as within the range of 140-150 mm, e.g. 145 mm, the length of the brush 2 being the longitudinal part of the brush being provided with bristles 5.

In some embodiments of the present invention, the end (also called tip herein) of each of at least some, or all, of the bristles of the first and/or second brushes 2a and/or 2b is flattened, e.g. to a shovel form. A flattened bristle tip may increase the agitation of the cleaning liquid, facilitating the cleaning of the paintbrush. Also, a flattened bristle tip may more easily penetrate between the bristles of the paintbrush, improving cleaning thereof.

FIG. 4 schematically shows, by curved arrows, how the cleaning liquid may flow in a figure “8” within the container 1 as the first and second brushes 2a and 2b rotate toward each other (as seen from above), pushing the cleaning liquid downward through the paintbrush being cleaned and toward the bottom 8 in the cross-sectional middle of the container, and upward along the lateral sides of the container. An optional lid of the container 1 may also be formed to guide the liquid flowing upwards along the lateral sides to flow back in between the brushes 2 and the paintbrush being cleaned. This figure-eight flow may be reinforces by the bottom 8 being inclined downward towards the cross-sectional middle of the container 1 (as discussed above), and/or by the bristle tips being flattened (as also discussed above).

FIG. 5 illustrates method steps of a method for using the paintbrush cleaning device 10 disclosed herein. The first and second brushes 2a and 2b are rotated S1 in contra-rotational sync such that the bristles 5 of both brushes 2 move down from the top 7 of the container 1 between the axes L of rotation. Then, a paintbrush is moved S2 through the opening 6 at the top 7 of the container 1 and in between the axes L of rotation such that the paintbrush is cleaned by the rotating brushes 2.

In some embodiments, the paintbrush cleaning device 10 comprises a drive, e.g. a motor, preferably an adjustable speed motor, e.g. an electrical motor of a drilling machine or a screwdriver, arranged to rotate the brushes 2 via the drivetrain 3. The drive is typically arranged outside of the container 1. The drive may be connected to the drivetrain 3 via a connection 12, e.g. through a side wall of the container 1. It has been shown that a suitable rotational speed for the rotation of the first and second brushes 2a and 2b, for improved cleaning without resulting in unnecessary wear on the paintbrush, may be within the range of 150-500 rpm, e.g. within the range of 300-450 rpm, such as 400 rpm. It has also been shown that such a rotational speed for the rotation of the first and second brushes 2a and 2b, e.g. within the range of 300-400 rpm, may heat the cleaning liquid at the bristle tips to a degree which facilitates cleaning of the paintbrush, especially if the bristle tips are flattened (as discussed above). The heating may result from friction with the cleaning liquid and, optionally, cavitation in the cleaning liquid at the bristle tips.

In some embodiments of the present invention, an upper horizontal surface of the cleaning liquid in the container 1, before the rotating S1 of the brushes 2 (or more generally when the brushes are not rotating and the surface is not agitated), is above the twisted stem wires 4 of the brushes 2. In some embodiments, the surface is below an axis of rotation of a drive, or of a connection 12, arranged for the rotating Si of the brushes 2 via the drivetrain 3.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. A paintbrush cleaning device, comprising:
a container arranged to hold a cleaning liquid;
a first twisted-in-wire brush, rotatably arranged in the container;
a second twisted-in-wire brush, rotatably arranged in the container; and
a drivetrain arranged to rotate the brushes in contra-rotational sync;
wherein each of the first and second brushes comprises:
twisted stem wires defining a central longitudinal axis of rotation of the brush; and
a plurality of bristles of equal length held by the twisted stem wires the bristle ends defining a diameter of the brush;
wherein the first and second brushes are arranged such that the axes of rotation are fixed in relation to the container and parallel to each other such that a paintbrush can be moved through an opening at a top of the container and in between the axes of rotation to be cleaned by the brushes when rotating; and
wherein the brushes overlap halfway between the axes of rotation, wherein the overlap is without the bristles of the first brush contacting the bristles of the second brush.

2. The device of claim 1, wherein the axes of rotation are arranged at a distance from each other within the range of 50-65 mm.

3. The device of claim 1, wherein that the overlap is at least 1 mm.

4. The device of claim 1, wherein each of at least some, or all, of the bristles of the first and/or second brushes is flattened at its end.

5. The device of claim 1, wherein the equal length of each bristle, from its end to the axis of rotation, is within the range of 25-35 mm.

6. The device of claim 1, wherein each of the bristles has a diameter within the range of 0.5-0.7 mm.

7. The device of claim 1, wherein the bristles are made of polyester.

8. The device of claim 1, wherein each of the brushes has a number of bristles per 100 mm along the rotational axis within the range of 300-400.

9. The device of claim 1, wherein each of the brushes has a length within the range of 100-200 mm.

10. The device of claim 1, wherein a bottom of the container is inclined towards a sealable opening for removing the cleaning liquid.

11. The device of claim 1, further comprising a right-circular cylindrical device arranged in a fixed position in the container, having a central longitudinal axis perpendicular to a plane of the axes of rotation and extending from below the brushes in the container towards a line halfway between the axes of rotation.

12. The device of claim 11, wherein the cylindrical device is a twisted-in-wire brush.

13. The device of claim 1, further comprising a drive, arranged to rotate the brushes via the drivetrain.

14. The device of claim 1, wherein the twisted stem wires are arranged to be below a surface of the cleaning liquid.

15. The device of claim 1, wherein the drivetrain comprises an upper gear arranged to be turned by a drive, and a respective lower gear of each of the first and second brushes, fastened to an end of said brush and in mesh with the upper gear.

16. The device of claim 15, wherein the upper gear is fastened to a connection through a side wall of the container, allowing a drive outside of the container to turn the upper gear via the connection.

17. A method to use a paintbrush cleaning device according to claim 1 the container (1) holding cleaning liquid, the method comprising:
rotating the brushes in contra-rotational sync such that the bristles of both brushes move down from the top of the container between the axes of rotation; and
moving a paintbrush through the opening at the top of the container and in between the axes of rotation such that the paintbrush is cleaned by the rotating brushes.

18. The method of claim 17, wherein the rotating of the brushes is at a rotational speed within the range of 150-500 rpm.

19. The method of claim 17, wherein an upper horizontal surface of the cleaning liquid in the container, before the rotating of the brushes, is above the twisted stem wires of the brushes.

20. The method of claim 19, wherein the upper horizontal surface of the cleaning liquid, before the rotating of the brushes, is below an axis of rotation of a drive arranged to rotate the brushes via the drivetrain.
